(19) United States
(12) Patent Application Publication
(10) Pub. No.: US 2017/0036429 A1
(43) Pub. Date: Feb. 9, 2017

(54) Multi-Layer Composite Film for the Construction Sector

(71) Applicant: Ewald Dörken AG, Herdecke (DE)

(72) Inventors: Carsten Harfmann, Frankfurt (DE); Rüdiger Laur, Dortmund (DE)

(73) Assignee: Ewald Dörken AG, Herdecke (DE)

(21) Appl. No.: 15/222,250

(22) Filed: Jul. 28, 2016

(30) Foreign Application Priority Data
Aug. 5, 2015 (DE) 102015009956.6
Sep. 21, 2015 (DE) 102015012015.8

(51) Int. Cl. B32B 27/12; B32B 27/40; B32B 5/02

(52) U.S. Cl. CPC B32B 27/12; B32B 5/028; B32B 5/022; B32B 27/40; B32B 5/024; B32B 2307/7265; B32B 2307/724; B32B 2262/0276; B32B 2419/00

(57) ABSTRACT

A multi-layer composite film is for the construction sector, particularly roof liner, underlay or façade liner, having at least one water-permeable and water-vapor-permeable nonwoven having polyester filaments, as the carrier layer, and a water-tight and water-vapor-permeable functional layer. The material of the functional layer has TPU, particularly consists of TPU. The TPU is a TPU of the carbonate type, and that the functional layer is extruded onto the carrier layer, so that the carrier layer and the functional layer are connected with one another by the extrusion process.

### CROSS REFERENCE TO RELATED APPLICATIONS

This application claims the benefit of and priority to German Patent Application No. 102015009956.6 filed Aug. 5, 2014 and German Patent Application No. 102015012 015.8 filed Sep. 21, 2015, both incorporated herein by reference in entirety.

### FIELD

The invention relates to a multi-layer composite film for the construction sector, particularly a roof liner, underlay or façade liner, having at least one water-permeable and water-vapor-permeable nonwoven containing polyester filaments as the carrier layer, and a water-tight and water-vapor-permeable functional layer, wherein the material of the functional layer contains TPU, particularly consists of TPU.

### BACKGROUND

Multi-layer composite films for the construction sector must be water-tight, for one thing, and for another must also be water-vapor-permeable, in order to be able to guarantee a diffusion-open structure, in any case a diffusion-braking but nevertheless water-tight structure of the building in this manner. Specifically for roof construction, protection against moisture (e.g. caused by condensate underneath the roofing), blowing snow and dirt is important. For the protective function, it is absolutely necessary that the membrane is not attacked and destroyed, neither by external mechanical effect nor by extremely long outdoor weathering, temperature, microorganisms, hydrolysis or by media that trigger corrosion.

In the case of multi-layer composite films, a distinction between two types is made, according to the functional layer or membrane. For one thing, microporous membranes are used, and for another, monolithic membranes are used as a functional layer that is open to water-vapor diffusion or brakes water-vapor diffusion. These are usually provided as a two-layer composite of the functional layer with a carrier layer, generally a nonwoven fabric.

Microporous membranes frequently consist of a hydrophobic polymer (e.g. polyethylene or polypropylene) having small pores. In this regard, water transport takes place using what is called Knudsen diffusion. In this regard, the pores are dimensioned in such a manner that individual water molecules pass through the membrane, but water under normal conditions, in other words up to a water column of 20 m, does not. It is problematic that the maximal water column also changes or decreases with contaminated water and thereby a changed surface tension of the water. In an extreme case, the surface tension can actually tend toward zero when what are called wetting agents are used. Ultimately, the membrane can lose its water-tightness in this process.

Monolithic membranes do not demonstrate the aforementioned behavior, because they are pore-free functional layers, in which the water-vapor transport takes place in a different manner than in the case of microporous linings. In this regard, the following sequence occurs for water-vapor transport:
Adsorption=pickup and physical binding of the water molecules on the membrane surface,
Absorption=penetration of the water molecules into the membrane,
Diffusion=transport of the water molecules through the membrane, wherein a prerequisite for this is a concentration gradient between the surfaces of the membrane,
Desorption=discharge into the gas space.

Usual polymers for monolithic membranes or functional layers for multi-layer composite films for the construction sector are:
thermoplastic polyurethanes (TPU) on the basis of polyether or polyester urethanes,
polyether ester elastomers,
polyamides,
PLA films,
copolyesters.

The aforementioned permeation processes are generally non-problematical for membranes composed of thermoplastic polyurethanes (TPU), polyether ester elastomers, and polyamides, if
a moderate climate is present,
the outdoor weathering time is limited to maximally 12 weeks,
the water is not contaminated by special solvents, wetting agents, wood protectants, strongly oxidizing liquids (e.g. for combating mold), acids or alkalis, and/or
possible prior damage of the membrane caused by mechanical damage, e.g. due to friction wear, UV radiation, or heat, as well as introduction of water into the roof construction is moderate.

If one or more of the aforementioned conditions are not met, the period of functioning of the membrane can be clearly restricted, i.e. permanent protection of the roof construction against moisture can no longer be guaranteed.

Studies have shown that well stabilized formulations of the material of the membrane layer in the case of an intact and therefore light-impermeable roof construction, a short outdoor weathering time, and a Central European climate meet the requirements set for roof survival. However, the aforementioned ideal conditions do not exist everywhere. Both in Germany and outside the country, regions exist where rather problematical climatic conditions prevail, which impair the function and the period of functioning of the membrane. Furthermore, damage cases show that premature failure of the monolithic membrane can even occur if, for example, outdoor weathering times are only slightly exceeded or if the introduction of moisture into the roof, for example through small defects, is increased.

### SUMMARY

It is now the task of the present invention to make available a multi-layer composite film of the type stated initially, which can be produced in a simple and cost-advantageous manner and guarantees permanent protection against moisture even in regions having different climatic conditions.

The aforementioned task is accomplished, according to the invention, in the case of a multi-layer composite film of the type stated initially, essentially in that the TPU is a TPU of the carbonate type, and that the functional layer is extruded onto the carrier layer. A non-releasable connection between the functional layer and the carrier layer occurs from this extrusion.

In the case of the invention, the combination of the carrier layer, configured as a polyester nonwoven, in connection with the TPU-carbonate-type functional layer, which is applied to the carrier layer in an extrusion process, has particular importance.

In connection with the present invention, it has been found that coating the carrier layer with the functional layer in an extrusion process does not cause any influence on the water-vapor permeability of the TPU-carbonate-type functional layer. Ultimately, the properties of the functional layer required for proper functioning are not impaired by this type of coating, which is furthermore cost-advantageous and can easily be integrated into the production process. Furthermore, it has been found that, in particular in the case of a carrier layer having polyester filaments, particularly good adhesion of the functional layer applied to the carrier layer by means of an extrusion process occurs, specifically without any prior treatment of the filaments of the nonwoven, at least on the coating side, and/or a supplemental adhesive layer or adhesive connection being required.

Ultimately, a composite having an adhesion of the layers connected with one another is produced by means of the embodiment according to the invention, as it cannot be achieved in the case of other material combinations, wherein at the same time, the properties of the functional layer required for proper functioning are not impaired in any way at all.

Furthermore, further significant advantages occur by using a TPU of the carbonate type, as compared with other TPU types.

A TPU of the carbonate type is understood to be a thermoplastic polyurethane that can be produced by means of polyaddition of an isocyanate with one or more polyols. It is characteristic and particularly advantageous for the TPU of the carbonate type that at least one of the polyols contains the structural element of a carbonic acid diester.

The isocyanates can be aliphatic diisocyanates, such as H12 MDI (1-isocyanate-4-[(4-isocyanate cyclohexyl) methyl] cyclohexane), HDI (1,6-hexamethylene diisocyanate) and/or IPDI (3-isocyanate methyl-3,5,5-trimethyl cyclohexyl isocyanate) or aromatic diisocyanates such as TDI (toluene-2,4-diisocyanate), NDI (naphthylene-1,5-diisocyanate) and/or MDI (methylene di(phenyl isocyanate)).

On the part of the polyols, these are aromatic or aliphatic polyols. Short-chain diols, in particular, are used as chain lengtheners. Thus, carbonic acid ester polyols are used, which are accessible by means of transesterification of carbonic acid diphenyl esters with diols, such as 1,6-hexane diol, for example. Furthermore, polycarbonate polyols can be used, which are accessible from the reaction of carbon dioxide with epoxies.

Experiments conducted with TPUs of the carbonate type, which contain polyols with the structural element of a carbonic acid ester and/or diester, have shown clear advantages as compared with TPUs of the ether or ester or ether-ester type.

A TPU ester type is understood to be a thermoplastic polyurethane that can be built up from an isocyanate and one or more polyols, by means of polyaddition, wherein at least one of the polyols contains the structural element of a carbonic acid ester. The isocyanates can be aliphatic diisocyanates, such as H12 MDI (1-isocyanate-4-[(4-isocyanate cyclohexyl) methyl] cyclohexane), HDI (1,6-hexamethylene diisocyanate) and IPDI (3-isocyanate methyl-3,5,5-trimethyl cyclohexyl isocyanate) or aromatic diisocyanates such as TDI (toluene-2,4-diisocyanate), NDI (naphthylene-1,5-diisocyanate) or MDI (methylene di(phenyl isocyanate)).

On the part of the polyols, these are aromatic or aliphatic polyols. Short-chain diols, in particular, are used as chain lengtheners.

In FIG. 2, a detail of a TPU ester type is shown in the region of the ester bond. The ester can be hydrolyzed by means of a reaction with water. In this regard, a stable, organic carbonic acid is formed. It is known that acids catalyze the hydrolysis of esters. Consequently, autocatalytic hydrolysis and thus self-accelerating decomposition of the TPU can come about.

TPUs of the ether type behave in a manner less susceptible to hydrolysis, but their resistance to UV stress or elevated temperatures is comparable to TPUs of the ester type.

In FIG. 1, a detail of a TPU of the carbonate type is shown in the region of the carbonate bond. The carbonic acid ester can be hydrolyzed by means of reaction with water. In this regard, an unstable monoester of carbonic acid forms, from which carbon dioxide is eliminated immediately. The gaseous carbon dioxide diffuses out of the polymer. Thus, no acidic compounds or functional groups remain behind during hydrolysis in the case of a TPU of the carbonate type, in contrast to a TPU of the ester type; the latter can have an autocatalytic effect.

Therefore TPUs of the carbonate type demonstrate clearly improved permanent operational reliability within the scope of use as a functional layer of a multi-layer film for the construction sector. The properties include:
clearly greater hydrolysis resistance,
clearly greater chemical resistance,
clearly better aging resistance at high temperatures,
improved weathering resistance, and
greater friction-wear resistance.

Furthermore, it has been found that TPUs of the carbonate type bring with them improved inherent flame-inhibiting behavior.

From these properties, it can be derived that when using a carbonate TPU, the weight per surface area of the monolithic functional film can be lowered, without
reducing the operational reliability as compared with previous films that are used in the construction sector,
ignoring official requirements with regard to the fire protection standards that must be observed.

This results in a resource-saving and cost-saving embodiment of a multi-layer film.

According to the invention, it has furthermore been found that to fulfill the required protective function, it is sufficient if the functional layer, when using a carbonate TPU, has a weight per surface area of 5 to 150 g/m². Preferably, the weight per surface area lies between 20 and 100 g/m², and further preferably, it lies between 30 and 80 g/m². In particular, weights per surface area between 35 and 45 g/m², on the one hand, and between 65 and 75 g/m², on the other hand, are significant. In this regard, it is understood that every intermediate interval and every individual value within the said interval ranges is possible.

Known TPU membranes of the ester or ether type have a clearly higher weight per surface area, if the same properties as in the case of a multi-layer composite film are supposed to be achieved as in the case of a functional layer according to the invention. At the same weight per surface area, the multi-layer composite film according to the invention, having a functional layer composed of a TPU of the carbonate type, is clearly superior.

In order to have a sufficiently good layer bond, it is provided, according to the invention, that the carrier layer has a proportion of 50% to 100% polyester filaments. Fundamentally, therefore, other fibers can also be provided in the carrier layer, wherein it is preferred that the proportion of polyester fibers predominates. It is particularly preferred if the nonwoven of the carrier layer consists entirely of polyester fibers.

In this connection, it is useful if the carrier layer has a weight per surface area between 50 g/m² to 300 g/m², particularly 80 g/m² to 150 g/m², and particularly between 100 g/m² and 120 g/m².

In general, it is sufficient if the multi-layer composite film has two layers, in other words has the carrier layer and the functional layer. However, for particular cases of use, a more than two-layer structure can also be provided. Thus, it is possible that at least two carrier layers are provided, between which the functional layer is then disposed in a sandwich-like manner. In this embodiment, as well, it is useful if the further carrier layer is ultimately connected with the functional layer by way of the extrusion process of the latter. In terms of method, it is then provided that the functional layer is first extruded onto the first carrier layer. In the inline method, the second carrier layer then runs onto the functional layer that is extruded on, as long as the latter is still in a corresponding (viscous) or not yet solidified state. The required layer bond is then strengthened by means of press-down rollers that are provided, if necessary.

Alternatively or supplementally to this, it is possible to provide at least one reinforcement layer composed of a woven reinforcement fabric or interlaid reinforcement scrim, with the carrier layer and the reinforcement layer consisting of different materials. With two carrier layers, a four-layer or five-layer structure is then possible. In this regard, the connection of the reinforcement layer(s) with the carrier layer can take place by way of a reactive hot-melt. This hot-melt, which only serves to connect the reinforcement layer or layers with the respective carrier layer, does not influence the water vapor permeability or other properties of the functional layer.

Fundamentally, it is also possible that the material of the reinforcement layer is worked into the carrier layer. In this manner, a reinforced carrier layer ultimately occurs.

Experiments have been conducted in connection with the invention, in order to document the improved properties of the functional layer with a TPU of the carbonate type as compared with a functional layer of a TPU of the ester type. The following Exemplary Embodiments 1 to 6 show this.

### EXEMPLARY EMBODIMENT 1

A polyester nonwoven having a grammage of 110 g/m², consisting of filament fibers, is coated with 40 g/m² TPU of the carbonate type in an extrusion process. To determine the aging resistance, the coated product is exposed to outdoor weathering under “Florida conditions” for eight weeks. The TPU functional layer is oriented relative to the sun at a 45° angle toward the south. Subsequently, the elongation to tear of the TPU functional layer is tested according to EN12311-1. This elongation to tear amounts to 89% of the initial value before outdoor exposure.

The term “Florida weathering” is understood to be a standardized method of the company Q-Lab for outdoor weathering. In this test, test pieces to be examined are exposed, in an outdoor weathering facility in the south of the U.S. state of Florida, to the climatic conditions that prevail there. Because of the high annual UV stress in combination with very high humidity, one-year exposure of the test piece, for example, to external ambient factors, can correspond to multiple years of weathering at other locations. In this regard, the tests take place according to the ASTM G7 2011 method. The samples tested in connection with the present invention are test pieces having a dimension of 30 cm length and 15 cm width. The test pieces were exposed to weathering in a frame, at an angle of 45° to the south, and directly.

### EXEMPLARY EMBODIMENT 2

A polyester nonwoven with a grammage of 110 g/m², consisting of filament fibers, is coated with 40 g/m² TPU of the ester type in an extrusion process. To determine the aging resistance, the coated product is exposed to outdoor weathering under “Florida conditions” for eight weeks. The TPU functional layer is oriented relative to the sun at a 45° angle to the south. Subsequently, the elongation to tear of the TPU functional layer is tested according to EN12311-1. This elongation to tear amounts to 40% of the initial value before outdoor weathering.

### EXEMPLARY EMBODIMENT 3

A polyester nonwoven with a grammage of 110 g/m², consisting of filament fibers, is coated with 70 g/m² TPU of the ester type. To determine the aging resistance, the coated product is exposed to outdoor weathering under “Florida conditions” for eight weeks. The TPU functional layer is oriented relative to the sun at a 45° angle to the south. Subsequently, the elongation to tear of the TPU functional layer is tested according to EN12311-1. This elongation to tear amounts to 85% of the initial value before outdoor weathering.

### EXEMPLARY EMBODIMENT 4

A polyester nonwoven with a grammage of 110 g/m², consisting of filament fibers, is coated with 70 g/m² TPU of the carbonate type in an extrusion process. The coated product is stored in a climate cabinet for twelve weeks, at 70° C. and 90% relative humidity. Subsequently, the elongation to tear of the TPU functional layer is tested according to EN12311-1. This elongation to tear amounts to 95% of the initial value before storage in the climate cabinet.

### EXEMPLARY EMBODIMENT 5

A polyester nonwoven with a grammage of 110 g/m², consisting of filament fibers, is coated with 70 g/m² TPU carbonate type in an extrusion process. The coated product demonstrates a resistance to the penetration of water according to DIN EN 20811 of >2000 cm water column. To determine the UV resistance, the coated product is exposed to UV radiation according to DIN EN 13859-1. After an irradiation period of 336 h, the resistance to penetration of water was determined according to DIN EN 20811, at >2000 cm water column. The measurements according to DIN EN 20811 fundamentally take place at a water temperature of 20° C. and an increase speed of the water pressure of 60 cm water column/min.

### EXEMPLARY EMBODIMENT 6

A polyester nonwoven with a grammage of 110 g/m², consisting of filament fibers, is coated with 70 g/m² TPU ester type in an extrusion process. The coated product demonstrates a resistance to penetration of water according to DIN EN 20811 of >2000 cm. To determine the UV resistance, the coated product is exposed to UV radiation according to DIN EN 13859-1. After an irradiation period of 336 h, the resistance to penetration of water was determined according to DIN EN 20811 at 789 cm water column. The measurements according to DIN EN 20811 fundamentally take place at a water temperature of 20° C. and an increase speed of the water pressure of 60 cm water column/min.

It follows from the exemplary embodiments that at least a grammage increase of 75% is required at a TPU of the ester type in comparison with a TPU of the carbonate type in order to achieve the same elongation to tear and the same resistance in the Florida aging test. Furthermore, it is evident from the exemplary embodiments that a multi-layer composite film according to the invention demonstrates increased hydrolysis stability. Ultimately, after 336 h UV irradiation according to DIN EN 13859, at the same TPU grammage, the resistance to penetration of water according to DIN EN 20811 is at least twice as high in the case of a TPU carbonate type in comparison with a TPU ester type.

Furthermore, the invention relates to a method for producing a multi-layer composite film of the aforementioned type, wherein coating the carrier layer with the functional layer takes place exclusively by means of an extrusion process, and the functional layer and the carrier layer are connected with one another by means of the extrusion process, specifically without further connection means or connection layers being provided. In the case of a three-layer structure of the multi-layer composite film, wherein the functional layer is then accommodated between two carrier layers, it is provided, in terms of method, that the functional layer is first extruded onto the first carrier layer and connected with the latter, and that subsequently, the second carrier layer runs in and is applied to the functional layer, which has not yet solidified, and is pressed on, if necessary, so that a firm connection between the second carrier layer and the functional layer occurs.

### BRIEF DESCRIPTION OF THE DRAWINGS

In the following, exemplary embodiments of the invention will be explained using the drawing. In this regard, all the characteristics described and/or shown in the drawing form the object of the present invention, by themselves or in any desired combination, independent of how they are summarized in the claims or their antecedents.

The figures show:

FIG. 1 a detail of a TPU of the carbonate type in the region of the carbonate bond,

FIG. 2 a detail of a TPU of the ester type in the region of the ester bond,

FIG. 3 a perspective view of a part of a multi-layer composite film according to the invention,

FIG. 4 a cross-sectional view of a first embodiment of a multi-layer composite film according to the invention,

FIG. 5 a cross-sectional view of a second embodiment of a multi-layer composite film according to the invention,

FIG. 6 a cross-sectional view of a third embodiment of a multi-layer composite film according to the invention,

FIG. 7 a cross-sectional view of a fourth embodiment of a multi-layer composite film according to the invention, and

FIG. 8 a cross-sectional view of a fifth embodiment of a multi-layer composite film according to the invention.

### DETAILED DESCRIPTION OF THE DRAWINGS

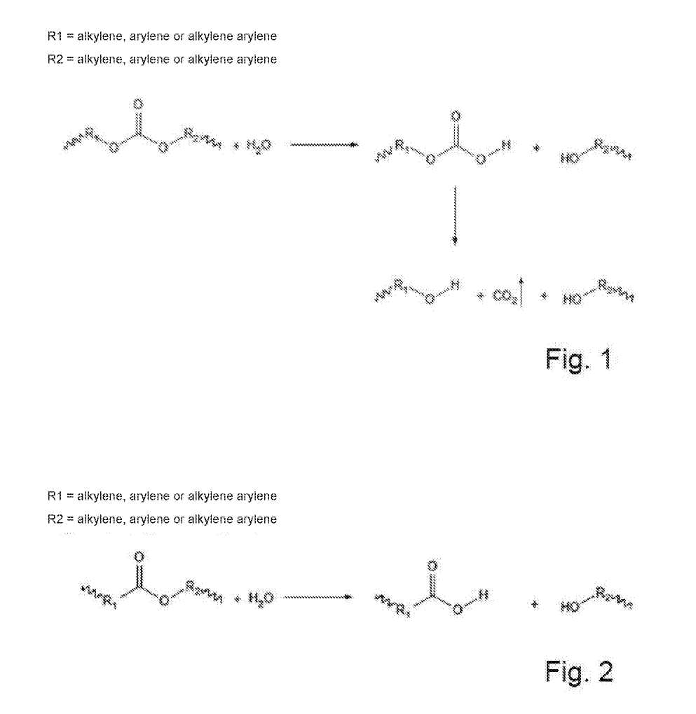

FIGS. 1 and 2, i.e. the representations of the details of a TPU of the carbonate type (FIG. 1) and a TPU of the ester type (FIG. 2), have already been discussed above. Reference is made to the explanations in this regard.

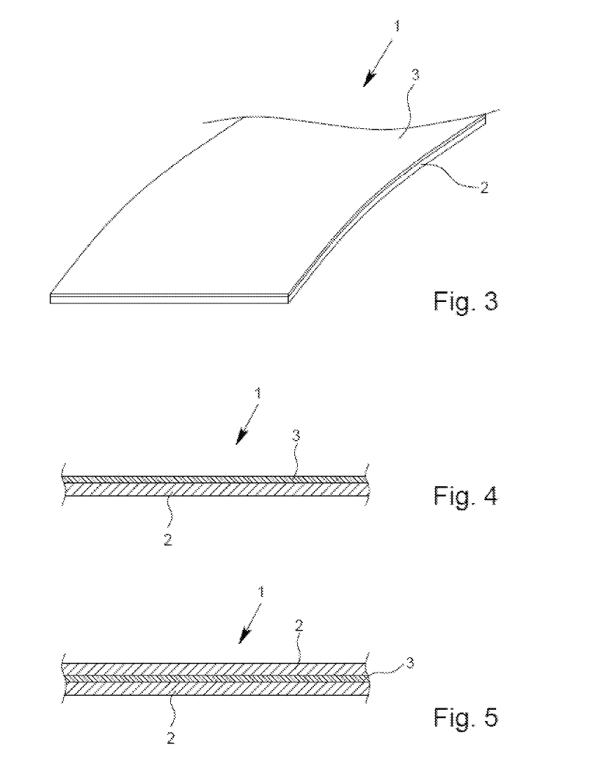

FIG. 3 shows a multi-layer composite film 1, which is intended for use in the construction sector. This can be, for example, a roof liner, an underlay or a façade liner. The multi-layer composite film 1, which is generally present as rolled material for purposes of storage and transport, has at least a water-permeable and water-vapor-permeable carrier layer 2 and a water-tight and water-vapor-permeable functional layer 3. The functional layer 3 is structured on a TPU basis. If the multi-layer composite film 1 is structured as a roof liner, multiple of these liners are laid onto the roof, overlapping at their longitudinal edges, and subsequently connected with one another. This can be done by way of an adhesive connection, a thermal weld connection or by way of a solvent weld connection.

In FIGS. 4 to 8, different embodiments of the multi-layer composite film 1 are shown in cross-section, as details.

FIG. 4 shows a two-layer structure. The carrier layer 2 is provided on the underside, while the functional layer 3 with the membrane composed of carbonate TPU is provided on the top side.

It is understood that in the embodiment according to FIG. 4, it is fundamentally also possible to dispose the carrier layer 2 on the top side.

The embodiment according to FIG. 5 has a three-layer structure, wherein the functional layer 3 is accommodated between two carrier layers 2, in sandwich-like manner. The two carrier layers 2 can but do not have to have the same thickness, and can but do not have to consist of the same material.

Fundamentally, it is also possible to provide a three-layer structure, not shown, that corresponds to the layer structure according to FIG. 5, but in place of a carrier layer, a reinforcement layer composed of a woven reinforcement fabric or an interlaid reinforcement scrim is provided. Here, the materials of the carrier layer 2 and the reinforcement layer are different.

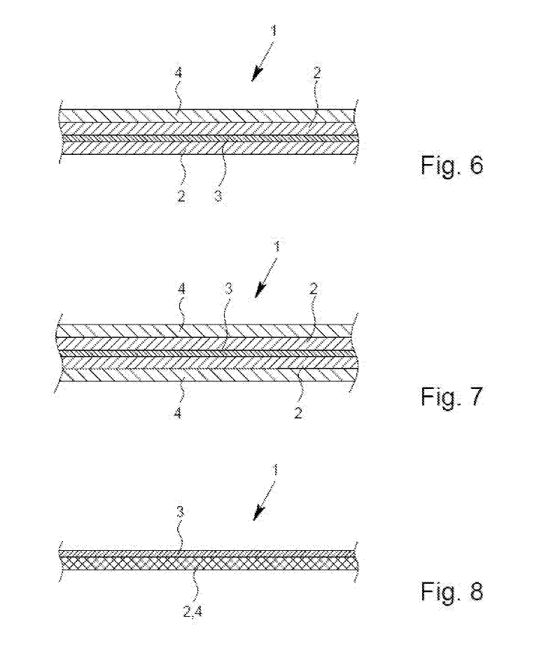

In FIG. 6, a four-layer structure is shown. This corresponds to the layer structure according to FIG. 5, with a supplemental reinforcement layer 4 being provided on the top side. In this regard, it is understood that the reinforcement layer 4 can also be provided on the underside. In this embodiment, as well, the materials of the carrier layer 2 and the reinforcement layer 4 are different. The materials of the carrier layers 2 are the same, in the present case, but can also be different.

In FIG. 7, an embodiment is shown, in which, proceeding from the embodiment according to FIG. 6, an additional reinforcement layer 4 is provided on the underside.

In the embodiment according to FIG. 8, once again a two-layer structure is provided. Here, the material of the reinforcement layer 4 is worked into the carrier layer 2. This is a combined carrier/reinforcement layer. It is understood that this combined layer can fundamentally also be provided on the top side of the functional layer 3.

In an embodiment that is not shown, a combined carrier/reinforcement layer can be provided both on the top side and on the underside.

In a further embodiment, not shown, a three-layer structure is provided, namely with a TPU functional layer, a central carrier layer, and a further TPU functional layer.

In all the embodiments, it is provided that the functional layer 3 is extruded onto the carrier layer 2 and that they are connected with one another by means of the extrusion process. In the case of a three-layer structure, wherein the functional layer 3 is disposed between the carrier layers in sandwich-like manner, after coating of the functional layer 3 onto the first carrier layer 2, the further carrier layer 3 is applied to the functional layer 3 that has not yet solidified. This takes place in an inline method, in which the further carrier layer 3 runs in and the three-layer composite is pressed by way of pressure rollers, so that a firm connection results from the extrusion process, also between the functional layer and the further carrier layer, specifically without adhesive, adhesive medium or other coatings of the fibers of the carrier layer being required.

### REFERENCE SYMBOL LIST

1 multi-layer composite film
2 carrier layer
3 functional layer
4 reinforcement layer

1. A multi-layer composite film for the construction sector, the multi-layer composite film comprising:
at least one water-permeable and water-vapor-permeable nonwoven having polyester filaments, as a carrier layer, and a water-tight and water-vapor-permeable functional layer;
wherein the functional layer has TPU of a carbonate type, and wherein the functional layer is extruded onto the carrier layer, so that the carrier layer and the functional layer are connected with one another by extrusion.

2. The multi-layer composite film according to claim 1, wherein the TPU is built up from one or more isocyanates and one or more polyols, particularly diols, by polyaddition.

3. The multi-layer composite film according to claim 1, wherein at least one of the polyols contains a structural element of at least one of a carbonic acid ester and diester.

4. The multi-layer composite film according to claim 2, wherein at least one of aromatic and aliphatic polyols, particularly short-chain diols, are provided as polyols.

5. The multi-layer composite film according to claim 1, wherein aliphatic diisocyanates, particularly at least one of H12 MDI (1-isocyanate-4-[(4-isocyanate cyclohexyl) methyl] cyclohexane), HDI (1,6-hexamethylene diisocyanate) and IPDI (3-isocyanate methyl-3,5,5-trimethyl cyclohexyl isocyanate) or aromatic diisocyanates are provided as isocyanates.

6. The multi-layer composite film according to claim 2, wherein polyols are provided, which are accessible by transesterification of carbonic acid diphenyl esters with diols.

7. The multi-layer composite film according to claim 1, wherein the carrier layer has a proportion of 50% to 100% of polyester filaments.

8. The multi-layer composite film according to claim 1, wherein the carrier layer has a weight per surface area of 50 to 300 g/m².

9. The multi-layer composite film according to claim 1, wherein the functional layer (3) has a weight per surface area of 5 to 150 g/m².

10. The multi-layer composite film according to claim 1, wherein at least one of two carrier layers and a reinforcement layer composed of a woven reinforcement fabric or interlaid reinforcement scrim are provided.

11. The multi-layer composite film according to claim 1, wherein the carrier layer and the reinforcement layer are made of different materials.

12. The multi-layer composite film according to claim 1, wherein an elongation to tear of the functional layer, after storage of 12 weeks at 70° C. and 90% humidity, amounts to at least 80% of an initial value.

13. A method for producing a multi-layer composite film comprising:
at least one water-permeable and water-vapor-permeable nonwoven having polyester filaments, as a carrier layer, and a water-tight and water-vapor-permeable functional layer;
wherein the functional layer has TPU of a carbonate type, and wherein the functional layer is extruded onto the carrier layer, so that the carrier layer and the functional layer are connected with one another by extrusion;
the method comprising:
coating the carrier layer and connecting the carrier layer with the functional layer by extrusion.

14. The method according to claim 13, wherein after coating, a further carrier layer or a reinforcement layer is applied to the functional layer, which has not yet solidified, and firmly connected with it.

15. A multi-layer composite film according to claim 2 wherein 1,6-hexane diol are provided, which are accessible from the reaction of carbon dioxide with epoxies.

16. A multi-layer composite film according to claim 2 wherein polycarbonate polyols are provided, which are accessible from the reaction of carbon dioxide with epoxies.

17. A multi-layer composite film according to claim 1, wherein the carrier layer has a weight per surface area of 80 to 150 g/m².

18. A multi-layer composite film according to claim 1, wherein the carrier layer has a weight per surface area of 100 to 120 g/m².

19. A multi-layer composite film according to claim 1, wherein the functional layer has a weight per surface area of 20 to 100 g/m².

20. A multi-layer composite film according to claim 1, wherein the functional layer has a weight per surface area of 30 to 80 g/m².

21. A multi-layer composite film according to claim 1, wherein an elongation to tear of the functional layer, after storage of 12 weeks at 70° C. and 90% humidity, amounts to at least 90% of an initial value.

22. A multi-layer composite film according to claim 1, wherein an elongation to tear of the functional layer, after storage of 12 weeks at 70° C. and 90% humidity, amounts to more 90% of an initial value.
